(19) United States
(12) Patent Application Publication
(10) Pub. No.: US 2009/0283523 A1
(43) Pub. Date: Nov. 19, 2009

(54) Connectable cupcake holder

(76) Inventors: Sara Thomas, Los Angeles, CA (US); Han Choi, Glendale, CA (US)

Correspondence Address: TOPE-MCKAY & ASSOCIATES, 23852 PACIFIC COAST HIGHWAY #311, MALIBU, CA, 90265, US

(21) Appl. No.: 12/154,145

(22) Filed: May 19, 2008

(51) Int. Cl. B65D 51/00; B29C 45/14; B65D 25/20

(52) U.S. Cl. 220/200; 264/242; 220/694

(57) ABSTRACT

A connectable cupcake holder is disclosed. The device comprises a base portion defining a recess for holding a pastry, a lid portion at least partially detachably attachable with the base portion for enclosing the pastry in the recess of the base, and at least one connector portion on an outer perimeter of the base, the connector portion detachably attachable with a connector portion of another cupcake holder, whereby a cupcake can be placed in the recess of the base and enclosed by the lid, and where a plurality of cupcake holders can be connected together and carried as a unit. The device further comprises a handle portion detachable attachable with the lid via a handle clip.

### BACKGROUND OF THE INVENTION

(1) Field of Invention The present invention relates to a pastry holding device and, more specifically, to a cupcake holder connectable with one or more other cupcake holders.

(2) Description of Related Art

Pastry holding devices have long been known in the art. Bakers have pastry trays for holding a plurality of pastries, including trays for holding cupcakes. U.S. Pat. No. 5,967,323 to Siragusa discloses a portable cupcake riddle comprising a base portion with a plurality of recesses for holding a plurality of cupcakes, and a lid portion having a handle for connecting with the base portion and covering and hermetically sealing in the cupcakes. The Siragusa device is designed to carry a large number of cupcakes and would not be useful for economical transport of only a small number of cupcakes, like in a child's lunch.

The closest related art known to the Applicant is U.S. Pat. No. 6,896,140 to Perry disclosing a crushproof cupcake holder for holding a single cupcake. The Perry device comprises a base for holding a pastry operationally connected with a lid for enclosing the pastry within the base. The Perry device is convenient for economical transport of a single cupcake, but is not connectable with another cupcake holder for optional transport of multiple cupcakes.

Therefore, a continuing need exists for a small, portable cupcake holder that provides the user with the option of carrying a single cupcake, or optionally connecting a plurality of cupcake holders for transport of a plurality of cupcakes.

### SUMMARY OF INVENTION

The present invention relates to a pastry holding device and, more specifically, to a cupcake holder connectable with one or more other cupcake holders. The device comprises a base portion defining a recess for holding a pastry, a lid portion at least partially detachably attachable with the base portion for enclosing the pastry in the recess of the base, and at least one connector portion on an outer perimeter of the base, the connector portion detachably attachable with a connector portion of another cupcake holder, whereby a cupcake can be placed in the recess of the base and enclosed by the lid, and where a plurality of cupcake holders can be connected together and carried as a unit.

In another embodiment, the at least one connector portion comprises two connector portions located on approximately opposite sides of the base, each connector portion comprising a slot bounded by grooved lips and having a width.

In another embodiment, the slots of the two connector portions differ in width relative to each other, one slot being wider than the other, such that the narrower slot of one cupcake holder can slide into and be frictionally retained by the wider slot of another cupcake holder, whereby a plurality of cupcake holders can be connected in series.

In yet another embodiment, the slots of the two connector portions are of the same width relative to each other.

In a further embodiment, lid portion is detachably attachable with the base portion via a twist-lock mechanism, where the perimeter of the recess in the base contains at least one groove, and where the lid has at least one protruding lip for sliding into the groove and being frictionally retained in the groove, where the lid is locked in place by inserting the lid into the recess of the base and turning the lid so that the at least one protruding lip of the lid slides into the at least one groove of the base.

In another embodiment, the device further comprises a handle portion, the handle having two ends, one end of the handle being detachably attachable with the lid of one cupcake holder via a handle clip, and the other end being detachably attachable with a lid portion of another cupcake holder via another handle clip, whereby a user can carry a plurality of connected cupcake holders by virtue of the handle.

In yet another embodiment, the handle portion is detachably attachable with the lid portion via a handle clip, where each end of the handle portion is substantially hook shaped, where the handle clip substantially comprises a loop, and where the hook of the handle fits within and is retained by the loop of the handle clip.

A further embodiment of the present invention comprises a pair of connectable cupcake holders, where one of the cupcake holders comprises two connector portions having slots of one width, and the other cupcake holder comprises connector portions having slots of a different width, the difference in widths being such that one of the connector portions of one cupcake holder can fit snugly into and be frictionally retained by one of the connector portions of the other cupcake holder, whereby a plurality of cupcake holders can be carried in series.

Finally, as can be appreciated by one in the art, the present invention also comprises a method for forming and using the cupcake holder described herein.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a perspective-view illustration showing a base portion of a cupcake holder having two connector portions;

FIG. 2 is a perspective-view illustration showing how two base portions may be connected via their respective connector portions;

FIG. 3 is a perspective-view illustration showing a lid portion detachably attachable with a base portion;

FIG. 4 is a perspective-view illustration showing how a handle portion may be connected to the lids of two cupcake holders via two handle clips; and

FIG. 5 is a perspective-view illustration showing the complete assembly of a pair of cupcake holders according to the present invention.

### DETAILED DESCRIPTION

The present invention relates to a pastry holding device and, more specifically, to a cupcake holder connectable with one or more other cupcake holders. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is only one example of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Further, if used, the labels left, right, front, back, top, bottom, forward, reverse, clockwise and counter clockwise have been used for convenience purposes only and are not intended to imply any particular fixed direction. Instead, they are used to reflect relative locations and/or directions between various portions of an object.

The present invention relates to a pastry holding device and, more specifically, to a cupcake holder connectable with one or more other cupcake holders.

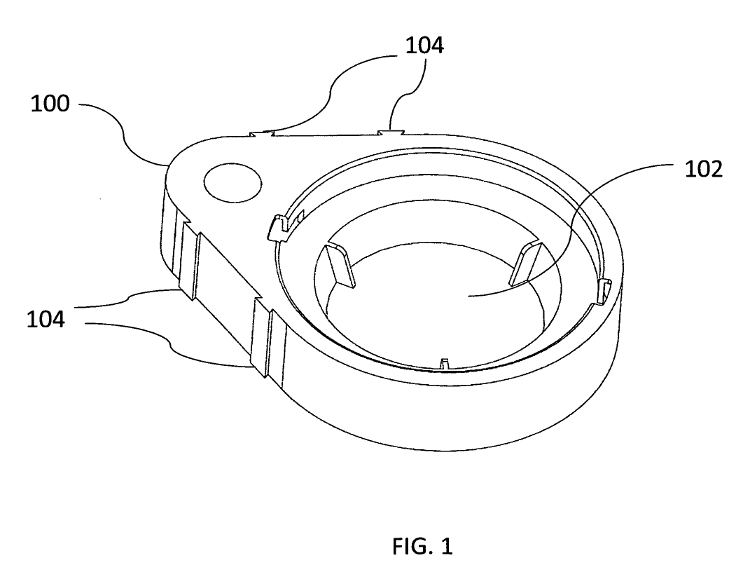

The device has a base portion 100 defining a recess 102 for holding a pastry, as shown in FIG. 1. The base 100 shown is substantially pear-shaped, but the present invention could potentially incorporate a base of any shape capable of defining a recess 102 for holding a pastry. Furthermore, the recess 102 shown in FIG. 1 is substantially circular in shape, but the present invention could potentially incorporate a recess of any shape suitable for holding a pastry.

The base has at least one connector portion 104 on the outer perimeter of the base 100, the connector portion detachably attachable with a connector portion of another cupcake holder. The embodiment shown in FIG. 1 has two connector portions 104 located on substantially opposite sides of the base 100, but present invention could still function with one, three or more connector portions. In the embodiment shown, each connector portion 104 comprises a slot bounded by grooved lips 104 and having a width.

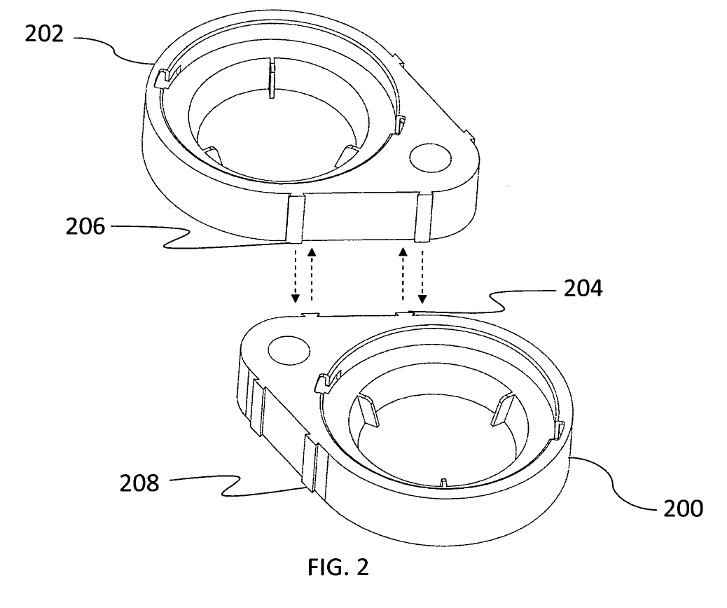

FIG. 2 shows how two base portions 200 and 202 can be connected by sliding the connector portion 204 of one base portion 200 into the connector portion 206 of the other base portion 202. This requires that the widths of the slots of the connector portions 204 and 206 be of different relative to each other, such that the connector portion having a smaller width 204 fits snugly into and is frictionally retained by the connector portion having a larger width 206. The connector portions located on the same base 204 and 208, as shown in FIG. 2, are of the same width, however, they can also be of different relative widths. In either case, a wide connector on one base must connect with a narrow connector on another base, and vice versa.

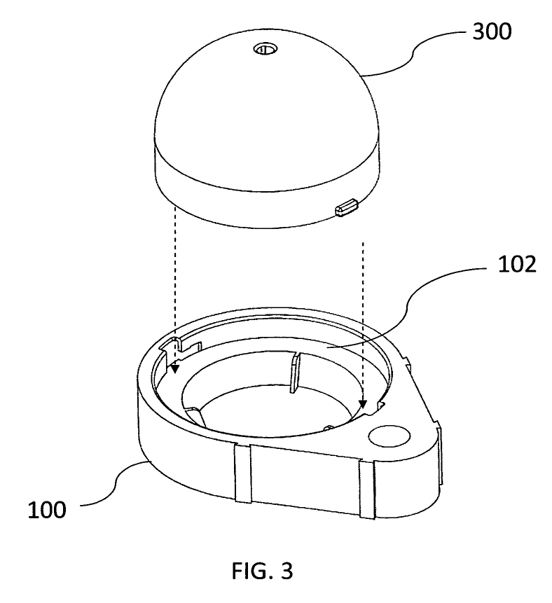

The device also comprises a lid portion 300, as shown in FIG. 3. The lid is at least partially detachably attachable with the base portion 100 for enclosing the pastry in the recess 102 of the base 100. The lid may be attached with the base by a variety of mechanisms, non-limiting examples being a hinge attachment, frictional attachment by virtue of a tight fit, and a twist-lock mechanism, where the perimeter of the recess in the base contains at least one groove, and where the lid has at least one protruding lip for sliding into the groove and being frictionally retained in the groove, where the lid is locked in place by inserting the lid into the recess of the base and turning the lid so that the at least one protruding lip of the lid slides into the at least one groove of the base.

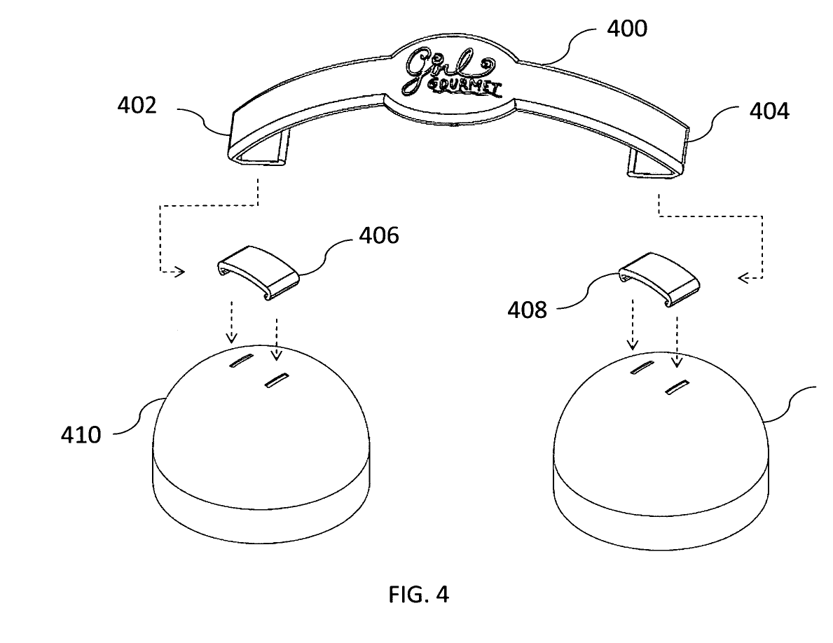

In another embodiment, and as shown in FIG. 4, the device further comprises a handle portion 400, the handle having two ends 402 and 404, one end of the handle 402 being detachably attachable with the lid of one cupcake holder 410 via a handle clip 406, and the other end 404 being detachably attachable with a lid portion of another cupcake holder 412 via another handle clip 408, whereby a user can carry a plurality of connected cupcake holders by virtue of the handle 400. In the embodiment shown, the handle ends 402 and 404 are substantially hook-shaped, and the handle clips 406 and 408 comprise a substantial loop, where the handle end 402 and 404 fits within and is retained by the loop of the handle clip 406 and 408.

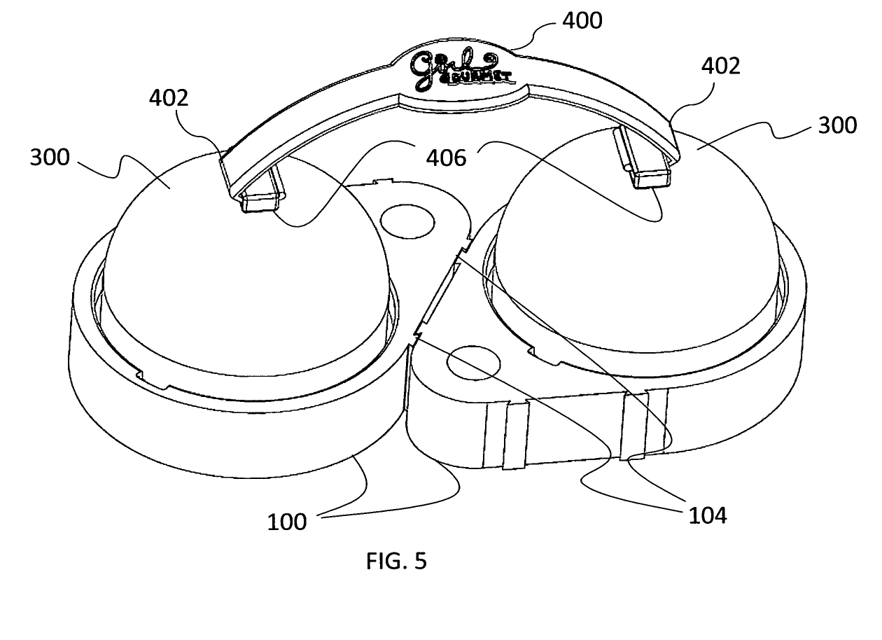

FIG. 5 shows a complete assembly of a pair of cupcake holders according to the present invention. The complete assembly includes a pair of base portions 100 connected via their respective connector portions 104. A lid 300 is detachably attached to each base 100, and a handle 400 having two ends 402 is detachably attached with the top of the lids 300 via a pair of handle clips 406.

Finally, as can be appreciated by one in the art, the present invention also comprises a method for forming the cupcake holder described herein. The method of forming the cupcake holder comprises acts of forming a base portion defining a recess for holding a pastry, forming a lid portion at least partially detachably attachable with the base portion for enclosing the pastry in the recess of the base, and attaching at least one connector portion on an outer perimeter of the base, the connector portion detachably attachable with a connector portion of another cupcake holder. The method can further comprise an act of forming a handle portion having two ends, one end of the handle being detachably attachable with an apex of the lid of one cupcake holder via a handle clip, and the other end being detachably attachable with an apex of a lid portion of another cupcake holder via another handle clip, whereby a user can carry a plurality of connected cupcake holders by virtue of the handle.

What is claimed is:

1. A connectable cupcake holder, comprising:
a base portion defining a recess for holding a pastry;
a lid portion at least partially detachably attachable with the base portion for enclosing the pastry in the recess of the base; and
at least one connector portion on an outer perimeter of the base, the connector portion detachably attachable with a connector portion of another cupcake holder,
whereby a cupcake can be placed in the recess of the base and enclosed by the lid, and where a plurality of cupcake holders can be connected together and carried as a unit.

2. The cupcake holder of claim 2, wherein the at least one connector portion comprises two connector portions located on approximately opposite sides of the base, each connector portion comprising a slot bounded by grooved lips and having a width.

3. The cupcake holder of claim 2, wherein the slots of the two connector portions differ in width relative to each other, one slot being wider than the other, such that the narrower slot of one cupcake holder can slide into and be frictionally retained by the wider slot of another cupcake holder, whereby a plurality of cupcake holders can be connected in series.

4. The cupcake holder of claim 2, wherein the slots of the two connector portions are of the same width relative to each other.

5. The cupcake holder of claim 1, wherein the lid portion is detachably attachable with the base portion via a twist-lock mechanism, where the perimeter of the recess in the base contains at least one groove, and where the lid has at least one protruding lip for sliding into the groove and being frictionally retained in the groove, where the lid is locked in place by inserting the lid into the recess of the base and turning the lid so that the at least one protruding lip of the lid slides into the at least one groove of the base.

6. A cupcake holder as in claim 1, further comprising a handle portion, the handle having two ends, one end of the handle being detachably attachable with the lid of one cupcake holder, and the other end being detachably attachable with a lid portion of another cupcake holder, whereby a user can carry a plurality of connected cupcake holders by virtue of the handle.

7. A cupcake holder as in claim 6, wherein the handle portion is detachably attachable with the lid portion via a handle clip, where each end of the handle portion is substantially hook shaped, where the handle clip substantially comprises a loop, and where the hook of the handle fits within and is retained by the loop of the handle clip.

8. A pair of connectable cupcake holders, each of the pair being as described in claim 2, where one of the cupcake holders comprises two connector portions having slots of one width, and the other cupcake holder comprises connector portions having slots of a different width, the difference in widths being such that on of the connector portions of one cupcake holder will fit snugly into and be frictionally retained by one of the connector portions of the other cupcake holder, whereby a plurality of cupcake holders can be connected in series.

9. A method of forming a cupcake holder comprising acts of:
forming a base portion defining a recess for holding a pastry;
forming a lid portion at least partially detachably attachable with the base portion for enclosing the pastry in the recess of the base; and
attaching at least one connector portion on an outer perimeter of the base, the connector portion detachably attachable with a connector portion of another cupcake holder,
whereby a cupcake can be placed in the recess of the base and enclosed by the lid, and where a plurality of cupcake holders can be connected together and carried as a unit.

10. The method of claim 9, further comprising the act of forming a handle portion, the handle having two ends, one end of the handle being detachably attachable with an apex of the lid of one cupcake holder via a handle clip, and the other end being detachably attachable with an apex of a lid portion of another cupcake holder via another handle clip, whereby a user can carry a plurality of connected cupcake holders by virtue of the handle.
